(19) United States
(12) Patent Application Publication
(10) Pub. No.: US 2001/0036147 A1
(43) Pub. Date: Nov. 1, 2001

(54) Latch mechanism for a disc drive

(76) Inventors: David Douglas Koester, Chanhassen, MN (US); Michael David Schroeder, Webster, MN (US)

Correspondence Address: Joseph R. Kelly, WESTMAN CHAMPLIN & KELLY, Suite 1600 - International Centre, 900 South Second Avenue, Minneapolis, MN, 55402-3319, US

(21) Appl. No.: 09/822,901

(22) Filed: Mar. 30, 2001

Related U.S. Application Data
(60) Provisional application No. 60/193,688, filed on Mar. 31, 2000.

(51) Int. Cl. G11B 21/16

(52) U.S. Cl. 369/256

(57) ABSTRACT

A latch mechanism is used with a disc drive. The latch mechanism includes an arm portion with an extending end portion. The extending end portion is configured to allow rotation of an actuator on the disc drive into an operable position during merging of the actuator onto a disc stack in the disc drive.

### FIELD OF THE INVENTION

The present invention deals with a latch assembly for use in a disc drive. More specifically, the present invention deals with a latch assembly configured to enable more efficient merging of an actuator onto a disc stack.

### BACKGROUND OF THE INVENTION

Disc drives are typically used for information storage and utilize at least one rotatable disc with concentric data tracks defined thereon for storing data. A data head (or transducer) accesses the disc surface to read data from, arid write data to, the various tracks on the disc. The transducer is coupled to, or formed integrally with, an actuator arm which moves the transducer relative to the disc surface in order to access prespecified portions of the disc surface.

In some conventional disc drives, a rotary voice coil motor is attached to a rear portion of the actuator arm which supports the transducer. The voice coil motor powers pivotal movement of the actuator relative to the disc surfaces. In order to prevent damage to the surface of the disc, such as when the discs are not rotating, conventional disc drives park the transducer in a landing zone on the disc surface which contains no data. In this way, the likelihood of contact with the disc by the transducer is decreased to avoid any significant damage to the disc surface or loss of recorded data.

However, even if the transducer is parked, the actuator may still pivot, such as when it is impacted by an external force. Such a force may dislodge the actuator from its parked position and move the transducer relative to the disc surface. In a conventional disc drive, when the disc is not rotating, there is no force imparted on the transducer to keep the transducer from undesirably contacting the disc surface and thus causing damage to the disc surface. Therefore, when the actuator moves out of its parked position (such as through an impact) and when the disc is not being rotated, the disc surface will likely be damaged. Therefore, many conventional actuators have locking or latching assemblies which impose a latching force on the actuator to inhibit movement of the actuator when it is in the parked position.

Many prior latch mechanisms encountered many difficulties. For example, such latch mechanisms were prone to failure in the locked position and thus prevent further use of the disc drive until repaired. Also, some latch mechanisms required their own power sources which increased the power demand of the disc drive and generated an undesirable amount of heat within the disc drive.

One common latch is a magnetic latch. Magnetic latches are commonly movable in a bistable manner between a latching position and an unlatching position. In the latching position, the magnetic latch exerts a locking force on the actuator arm holding it in place. The latching force can be overcome by the normal actuation of the actuator such that the actuator can be released for movement during operation of the disc drive.

A problem related to the latch mechanism is associated with merging the actuator onto the disc stack during assembly. In other words, the disc drives often include a number of stacked disc platters which are mounted for rotation about a common spindle. Each disc surface often has an associated actuator arm and transducer. In order to assemble the actuator relative to the disc stack, the actuator assembly (including the plurality of actuator arms) is merged onto the disc stack such that the actuator arms are inserted between the individual discs in the disc stack. However, if the magnetic latch happens to be in the latching position when the actuator is rotated onto the disc stack during merging, the latching mechanism can actually engage the actuator and thereby prevent rotation of the actuator onto the disc stack, and thus prevent merging. Such a disc drive then requires manual repositioning of the latch mechanism such that the actuators can be merged onto the disc stack.

### SUMMARY OF THE INVENTION

A latch mechanism is used with a disc drive. The latch mechanism includes an arm portion with an extending end portion. The extending end portion is configured to allow rotation of an actuator on the disc drive into an operable position during merging of the actuator onto a disc stack in the disc drive.

### BRIEF DESCRIPTION OF THE DRAWINGS

FIG. 1 is an isometric view of a disc drive in accordance with one embodiment of the present invention.

FIGS. 2-4 illustrate a latch mechanism in accordance with the present invention in various positions.

FIG. 5 illustrates one embodiment of a latch mechanism in accordance with the prior art.

FIGS. 6 and 7 illustrate a latch mechanism in accordance with one embodiment of the present invention during merging of an actuator onto a disc stack.

### DETAILED DESCRIPTION OF ILLUSTRATIVE EMBODIMENTS

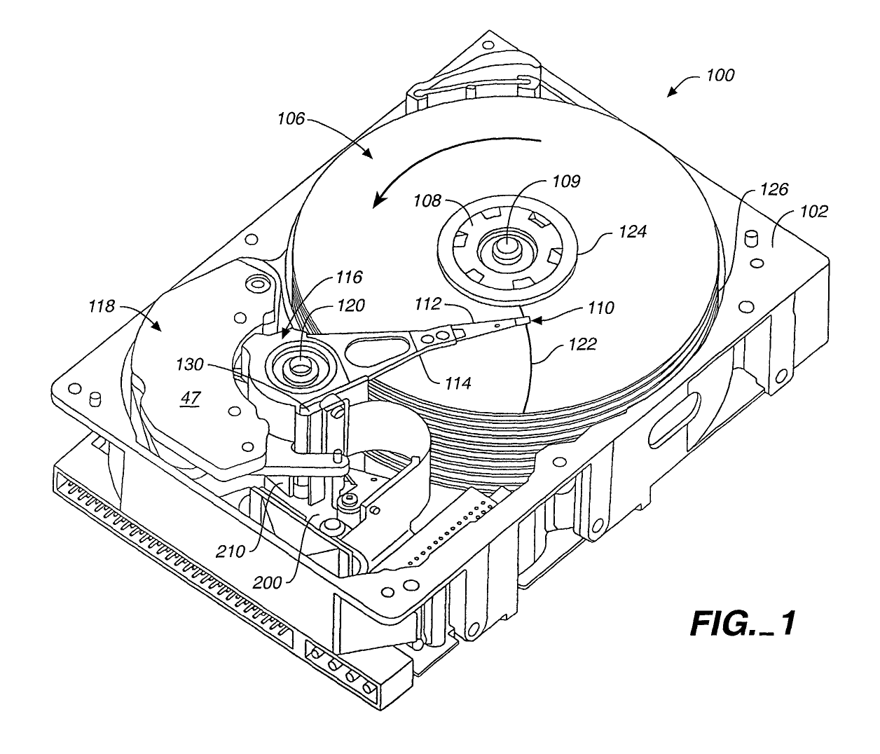

FIG. 1 is a perspective view of a disc drive 100 in which the present invention is useful. Disc drive 100 includes a housing with a base 102 and a top cover (not shown). Disc drive 100 further includes a disc pack 106, which is mounted on a spindle motor (not shown) by a disc clamp 108. Disc pack 106 includes a plurality of individual discs, which are mounted for co-rotation about central axis 109. Each disc surface has an associated slider 110 which is mounted to disc drive 100 for communication with the disc surface. In the example shown in FIG. 1, sliders 110 are supported by suspensions 112 which are in turn attached to track accessing arms (or actuator arms) 114 of an actuator 116. The actuator shown in FIG. 1 is of the type known as a rotary moving coil actuator and includes a voice coil motor (VCM), shown generally at 118. Voice coil motor 118 rotates actuator 116 with its attached heads 110 about a pivot shaft 120 to position heads 110 over a desired data track along an arcuate path 122 between a disc inner diameter 124 and a disc outer diameter 126. Voice coil motor 118 is driven by servo electronics 130 based on signals generated by heads 110 and a host computer (not shown).

Disc drive 100 also includes latch mechanism 200 in accordance with one embodiment of the present invention. Latch mechanism 200 is described in greater detail in the later figures. Briefly, however, when the actuator 116 is merged onto disc stack 106, each of the actuator arms 114 are positioned between the various discs in disc stack 106. The actuator is then rotated onto the discs such that the transducers 110 are rotated toward the inner diameters of the disc stack.

During operation of the disc drive, when access of data on the discs in the disc stack 106 is no longer desired, the actuator 114 is moved to a parked position where it is rotated, in one illustrative embodiment, to the very inner diameter 124 of the discs on disc stack 106. At this position, the voice coil motor 118 has a tab 210 thereon which engages latch mechanism 200 such that latch mechanism 200 is disposed in a locking position locking the actuator against rotation. However, when accessing of the disc surfaces is again desired, voice coil motor 118 is energized causing rotation of the actuator away from the inner diameter 124 of the discs. This energization overcomes the latching force inparted by latch 200 and thus allows the actuator to rotate under the influence of the voice coil motor 118 so that the transducers 110 can be positioned relative to the various disc surfaces in disc stack 106.

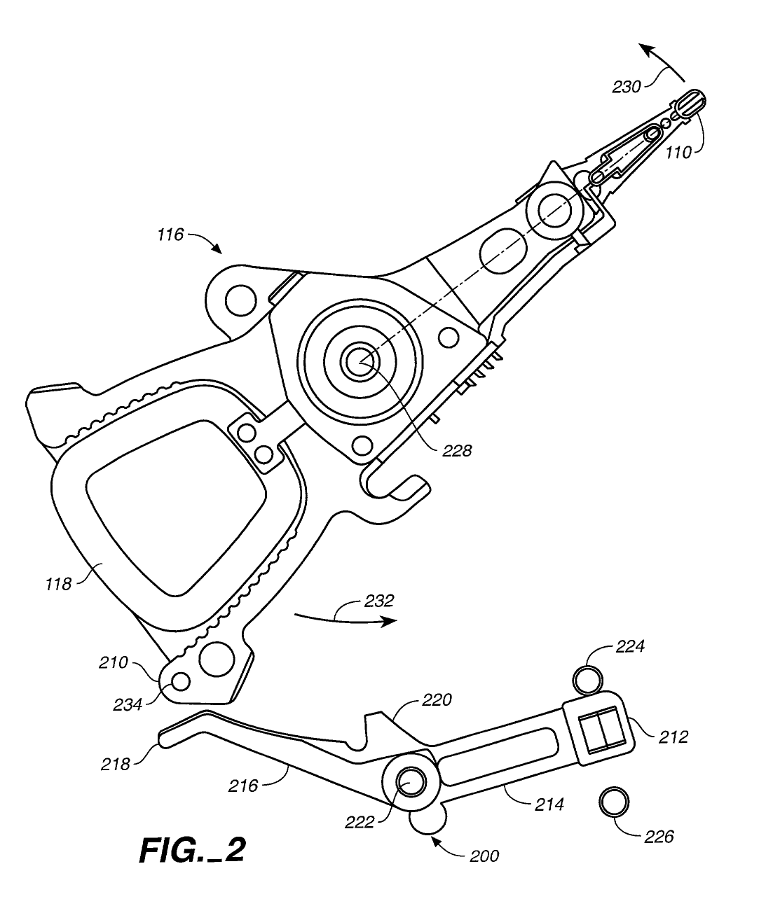

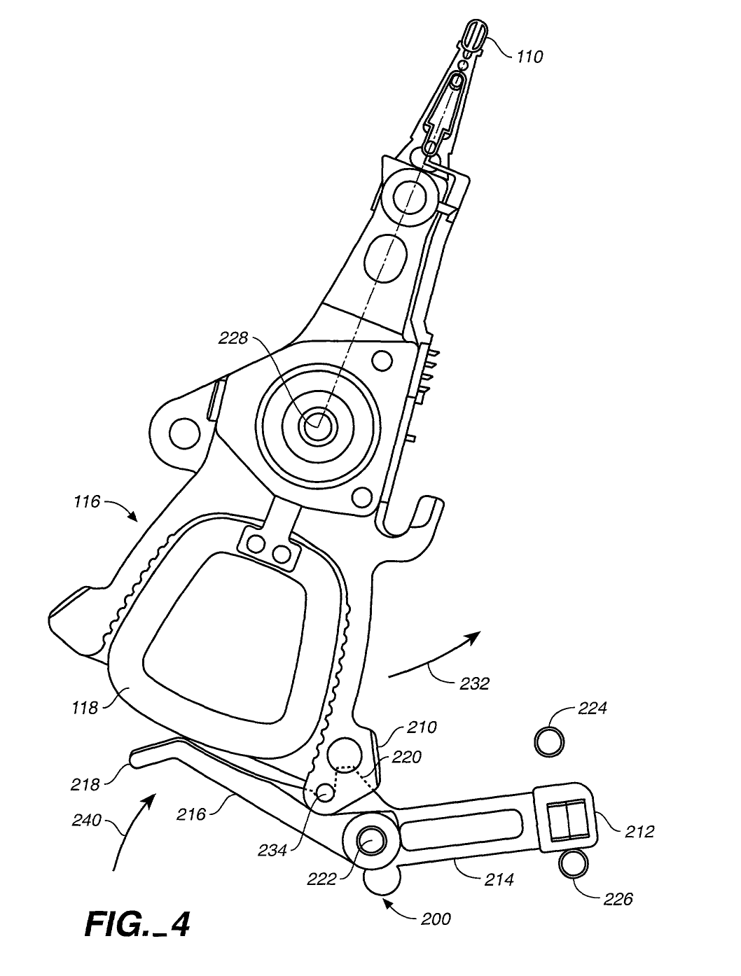

In order to better illustrate the invention, FIGS. 2-4 will first be described which illustrate the general operation of latch 200 in accordance with one illustrative embodiment of the present invention. FIG. 2 shows the actuator 116 and latch 200 in greater detail. Latch 200 illustratively includes a magnet portion 212. A first arm portion 214, a second arm portion 216, an extending finger 218 and a latching tab 220. Latch 200 is illustratively pivotable about a pivot axis 222 between an unlatching position (shown in FIG. 2) and a latching position (shown in greater detail in FIG. 4). When in the unlatching position shown in FIG. 2, magnet 212 is illustratively in a first bistable position adjacent pin 224. When latch 200 is in the latching position, magnet 212 is illustratively adjacent pin 226.

It will be appreciated that pins 224 and 226 are illustratively formed of magnetic material such that magnet 212, mounted on latch 200 is magnetically attracted to pins 224 and 226. Therefore, when magnet 212 is located closer to pin 224, it will exert an attraction force on pin 224 which is stronger than that on pin 226 and thus bias itself toward pin 224 (and hence toward the unlatching position). However, when magnet 212 is moved closer to pin 226, the magnetic interaction with pin 226 is stronger than that with pin 224 and thus latch 200 biases it self to the latching position in which magnet 212 is in contact with pin 226.

During assembly of disc drive 100, actuator 114 is merged onto disc stack 106. During merging, actuator 114 is rotated about axis 228 such that the transducers 110 move in the direction indicated by arrow 230, generally toward the inner radius of the discs on the disc stack 106. This, of course, causes voice coil motor 118 to rotate generally in the direction illustrated by arrow 232. When latch 200 is in the unlatching position, shown in FIG. 2, tab 210 (which includes an extending pin 234) rotates relative to latch 200 also generally in the direction indicated by arrow 232. It can be seen in FIG. 2, that when latch 200 is in the non-latching position, tab 210 and pin 234 can easily rotate in the direction indicated by arrow 232, without being obstructed by any portions of latch 200.

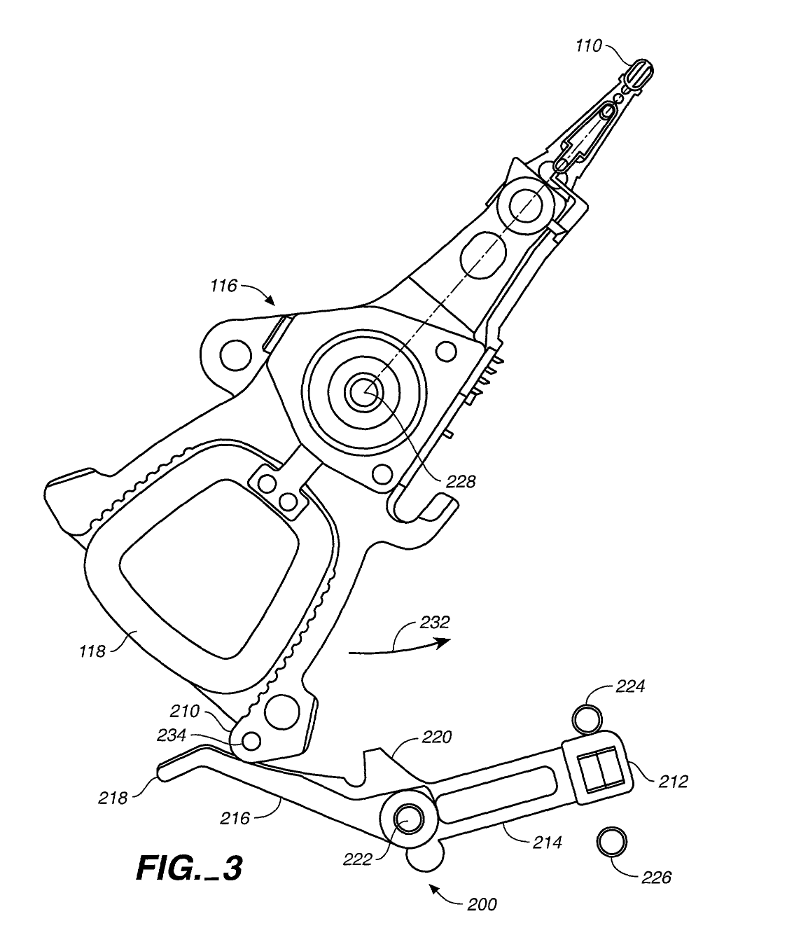

FIG. 3 illustrates the same items as those shown in FIG. 2, and they are similarly numbered. However, FIG. 3 shows actuator 116 in a typical operating position, where transducer 110 is positioned somewhere over the disc surface for accessing data on the surface of the disc. In this position, latch 200 is in the non-latching position. Again, it can be seen that tab 200 and pin 234 can easily move about the interior of the small arc formed by second arm portion 216 of latch 200 as the transducer swings about its arc over the disc surface.

FIG. 4 illustrates actuator 116 in yet another position. In FIG. 4, actuator 116 is shown rotated about axis 228 to a park position. Actuator 228 is in the park position, and thus positions transducer 110 over an extreme inner radius of the discs in the disc stack 106 when the discs are not being accessed. It can be seen from FIG. 4 that actuator 116 has rotated such that voice coil motor 118 has moved in the direction indicated generally by arrow 232 to a position in which pin 234 on tab 220 has contacted latching tab 220. Upon first contacting latching tab 220, voice coil motor 232 continues to move in the direction indicated by arrow 232. This causes latch 200 to rotate about axis 222 generally in the direction indicated by arrow 240. This drives magnet 212 out of contact with pin 224 and causes it to move about axis 222 in a direction generally toward pin 226. When actuator 116 is rotated to its park position, magnet 212 is in contact with pin 226. Thus, even when voice coil motor 118 is powered down, latch 200 acts to hold actuator 116 in the park position through the magnetic interaction of magnet 212 and magnetic pin 226. This inhibits actuator 116 from freely moving, such as during an external impact, over the disc surface and thereby destroying or otherwise damaging a portion of the disc surface.

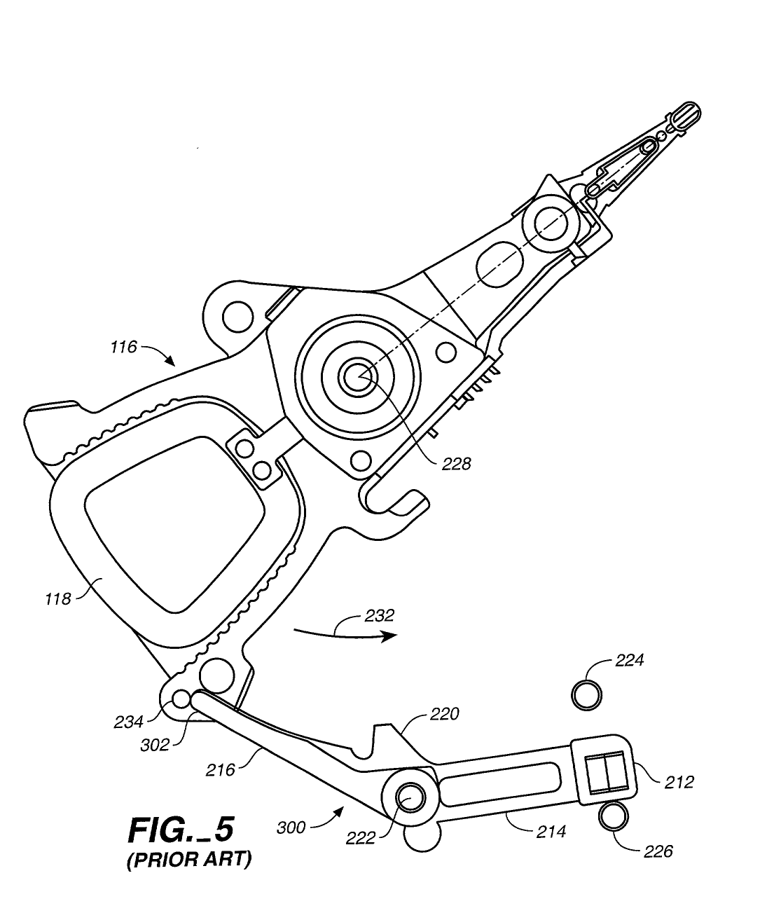

FIG. 5 illustrates a prior art latch mechanism 300. It can be seen that actuator 116 and latch 300 have many of the same parts as shown in previous figures, and those parts are similarly numbered. However, as shown in FIG. 5, latch 300 does not have extending finger 218. Instead, arm 216 simply ends with an in-line portion 302 which generally continues in linear fashion in the same direction as arm 216. However, this can present a problem as illustrated in FIG. 5.

During assembly of disc drive 200, latch 300 may be in the latching position, or the unlatching position. Since it remains in one position, or the other, simply through magnetic interaction between magnet 212 and pins 224 and 226, it is difficult to maintain latch 300 in any given position during handling of the disc drive components which is common during assembly. However, when latch 300, of the prior art, is in the latching position, prior to merging of actuator 116 onto the disc stack, end 302 of arm 216 is positioned to impede rotation of voice coil motor 118 in the direction shown by arrow 232.

Of course, after actuator 116 is merged on to the disc stack 106, pin 234 moves along the interior periphery of arm 216 in the same fashion as described above with respect to latch 200. However, during assembly, the merging process is impeded if latch 300 is in the latching position prior to the merging process. In that instance, the disc drive must be removed from the normal assembly process indicating that the merge failed. This requires manual repositioning of latch 300 into the unlatching position such that magnet 212 is pivoted about axis 222 and is adjacent pin 224. This, of course, would cause end 302 of arm 216 to rotate out of the way of pin 234 and allow the actuator to be merged with, and rotated onto, the disc stack 106. However, this extra handling operation is not only timely, but introduces additional human interaction into the assembly process and thus introduces additional sources of error.

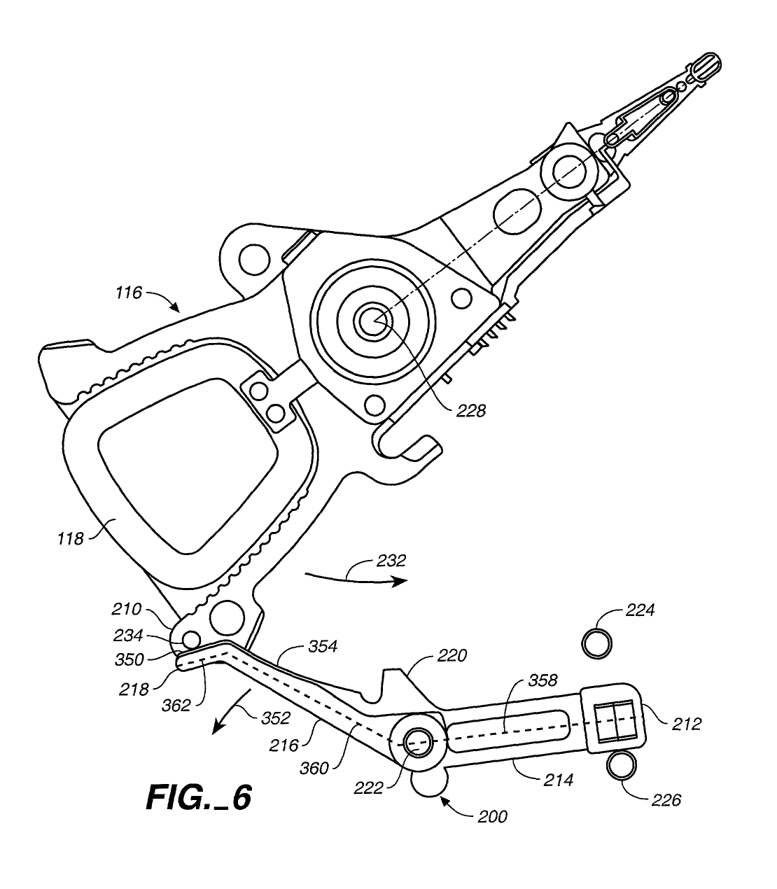

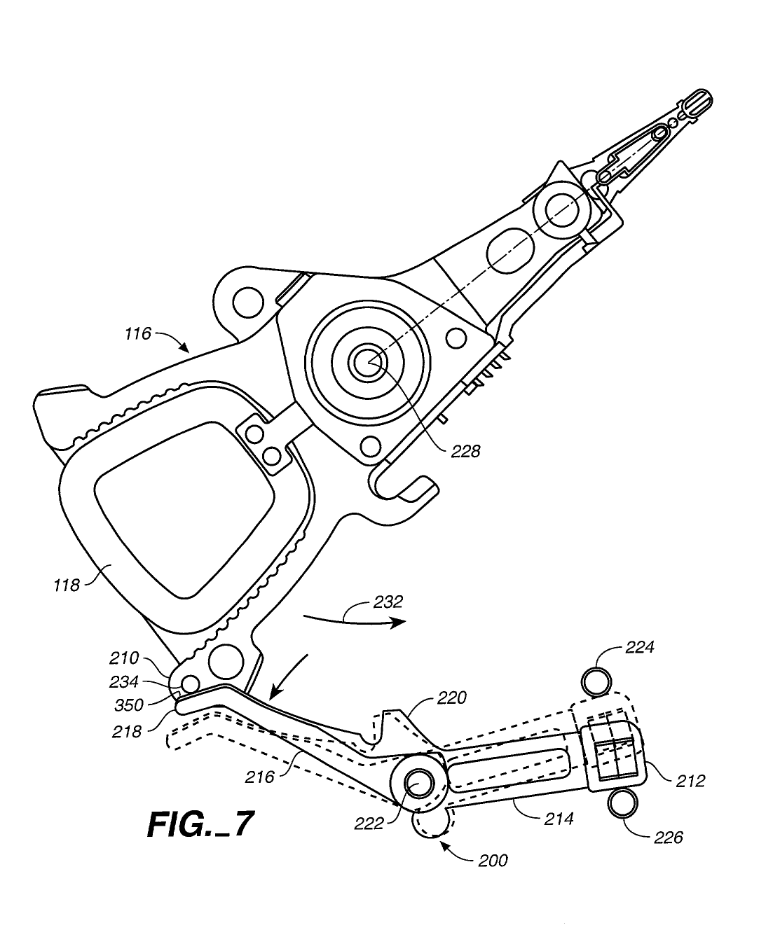

FIGS. 6 and 7 illustrate latch 200 in accordance with one illustrative embodiment of the present invention as it interacts with the actuator during the merge and rotation process in assembly. FIG. 6 shows latch 200 in the latched position in which magnet 212 is disposed against pin 226. FIG. 6 also shows that, contrary to the arrangement shown in FIG. 5 in which latch 300 precluded rotation of actuator 116 onto the disc stack 106, extending finger 218 of latch 200 has a surface 350 disposed relative to pin 234 such that, as actuator 116 is rotated onto the disc stack 106 in the direction generally indicated by arrow 232, pin 234 rides along surface 350 of extending finger 218. This drives latch 200 in the direction generally indicated by arrow 352. Of course, this drives magnet 212 in a direction generally away from pin 226 and toward pin 224. When magnet 212 is closer to pin 224 than it is to pin 226, the magnet attracts to pin 224, moving latch 200 into the unlatched position.

It will thus be appreciated that surface 350 is illustratively disposed at a non-orthogonal angle relative to the rotational arc traveled by pin 234. This, along with the length of extending finger 218, is sufficient such that, during the assembly process, when actuator 116 is rotated onto the disc stack 106, the force exerted by voice coil motor 118 in the direction of arrow 232 will drive movement of latch 200 into the unlatched position. Once actuator 116 is rotated onto the disc stack 106, pin 234 will never, during normal disc operation, contact surface 350. In other words, pin 234 will only move adjacent the general interior periphery 354 of the second arm portion 216, and will not move all the way out to the surface 350 of extending finger 218. Thus, during normal operation of the disc drive, actuator 116 will simply rotate causing latch 200 to move from the unlatched position to the latched position when the actuator is moved to the parking location on the disc surface.

FIG. 6 thus illustrates that, in one illustrative embodiment, first arm portion 214 of latch 200 has a generally longitudinal axis 358. Second arm portion 216 of latch 200 also has a generally longitudinal axis 360. Further, extending finger 218 illustratively has a generally longitudinal axis 362 which is disposed at an angle relative to longitudinal axis 360. Of note, axis 362 is disposed at a non-orthogonal angle relative to the direction of rotation of pin 234 (during rotation of the actuator onto the disc stack) which is sufficient to drive the latch from the latching position to the non-latching position as the actuator is rotated onto the disc stack. Of course, the angle can be any suitable angle and is illustratively between 0 and 90 degrees.

FIG. 7 illustrates the interaction of actuator 116 and latch 200, during merging and rotation of the actuator onto the disc stack, in greater detail. FIG. 7 better illustrates the initial contact of pin 234 with edge 350 of extending finger 218. As the actuator continues to rotate in the direction indicated by arrow 232, pin 234 rides against edge 350 eventually causing latch 200 to move to its alternate bistable position, the unlatched position, shown in phantom in FIG. 7.

A disc drive 100 includes a plurality of rotatable discs 106 each having a disc surface. An actuator 116 includes a plurality of actuator arms 114 supporting transducers 110 proximate the disc surfaces. The actuator 114 is pivotable through an arc 122 relative to the discs 106. A bistable latch 200 is pivotally mounted relative to the actuator 116 between an actuator locking position and an unlocking position. The latch 200 includes an actuator engaging portion 218 disposed to contact the actuator 116 during merging of the actuator 116 onto the discs 106 such that rotation of the actuator 116 moves the latch 200 from the actuator latching position to the unlatching position.

In one illustrative embodiment, the latch 200 includes a pivotal arm 216 having a generally longitudinal axis 360 and wherein engaging portion 218 comprises an extending finger having a generally longitudinal axis 362 extending non-coincidentally with the longitudinal axis 360 of the pivot arm 216.

In one embodiment, the finger portion 218 includes an actuator engaging surface 350 engageable with the actuator 116 during merging of the actuator 116 onto the discs 106. The surface can be disposed to non-orthogonally intersect the arc 232.

In one embodiment, the actuator 116 includes a surface engaging pin 234 extending therefrom and arranged to engage the actuator engaging surface 350 of the finger portion 218 during merging. The actuator may illustratively be rotatable through the arc 232 to a park position at one extreme end of travel. In the park position, the pin 234 engages the latch 200 to drive the latch 200 to the actuator locking position when the actuator is in the park position.

In one embodiment, the latch comprises a magnetic latch and the surface engaging pin 234 is non-engageable with the actuator engaging surface 350 during operation of the actuator 116 subsequent to merging.

In yet another embodiment, the actuator engaging region 218 is configured to interact with the actuator 116 to move the latch 200 from an actuator latching position to an unlatching position.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular arrangement of actuator 116 and latch 200, as well as on the shape of both, while maintaining substantially the same functionality without departing from the scope and spirit of the present invention.

What is claimed is:

1. A disc drive, comprising:
a plurality of rotatable discs each having a disc surface;
an actuator having a plurality of actuator arms supporting transducers proximate the disc surfaces, the actuator being pivotable through an arc relative to the discs; and
a bistable latch pivotally mounted relative to the actuator between an actuator latching position and an unlatching position, the latch including an actuator engaging portion disposed to contact the actuator during merging of the actuator onto the discs such that rotation of the actuator moves the latch from the actuator latching position to the unlatching position.

2. The disc drive of claim 1 wherein the latch comprises:
a pivotable arm having a generally longitudinal axis.

3. The disc drive of claim 2 wherein the actuator engaging portion comprises:
an extending finger having a generally longitudinal axis extending non-coincidentally with the longitudinal axis of the pivotable arm.

4. The disc drive of claim 3 wherein the finger portion includes an actuator engaging surface, engageable with the actuator during merging of the actuator onto the discs, the surface being disposed to non-orthogonally intersect the arc.

5. The disc drive of claim 4 wherein the actuator includes a surface engaging pin extending therefrom arranged to engage the actuator engaging surface of the finger portion during merging.

6. The disc drive of claim 5 wherein the actuator is rotatable through the arc to a park position at one extreme end of travel, wherein the pin engages the latch to drive the latch to the actuator latching position when the actuator is in the park position.

7. The disc drive of claim 1 wherein the latch comprises a magnetic latch.

8. The disc drive of claim 5 wherein the surface engaging pin is non-engageable with the actuator engaging surface during operation of the actuator subsequent to merging.

9. A disc drive, comprising:
a plurality of discs having disc surfaces;
an actuator pivotably supporting a plurality of actuator arms and transducers relative to the disc surfaces; and
a latch having an actuator engaging region engageable by the actuator during merging of the actuator onto the discs, the actuator engaging region being configured to interact with the actuator to move the latch from an actuator latching position to an unlatching position.

10. The disc drive of claim 9 wherein the actuator engaging region is disposed to contact the actuator during merging such that rotation of the actuator during merging moves the latch from the actuator latching position to the unlatching position.

11. The disc drive of claim 10 wherein the latch comprises:
a pivotable arm having a generally longitudinal axis.

12. The disc drive of claim 11 wherein the actuator engaging portion comprises:
an extending finger having a generally longitudinal axis extending non-coincidentally with the longitudinal axis of the pivotable arm.

13. The disc drive of claim 12 wherein the actuator is pivotable through an arc relative to the discs.

14. The disc drive of claim 13 wherein the finger portion includes an actuator engaging surface, engageable with the actuator during merging of the actuator onto the discs, the surface being disposed to non-orthogonally intersect the arc.

15. The disc drive of claim 14 wherein the actuator includes a surface engaging pin extending therefrom arranged to engage the actuator engaging surface of the finger portion during merging.

16. The disc drive of claim 15 wherein the actuator is rotatable through the arc to a park position at one extreme end of travel, the pin engaging the latch to drive the latch to the actuator latching position when the actuator is in the park position.

17. The disc drive of claim 9 wherein the latch comprises a magnetic latch.

18. The disc drive of claim 15 wherein the surface engaging pin is non-engageable with the actuator engaging surface during operation of the actuator subsequent to merging.

19. A disc drive, comprising:
a plurality of discs;
an actuator movably supporting a plurality of transducers relative to the discs; and
means for latching the actuator to inhibit movement of the actuator.
